(19) United States
(12) Patent Application Publication
(10) Pub. No.: US 2005/0190876 A1
(43) Pub. Date: Sep. 1, 2005

(54) Storing device

(76) Inventor: Christian L. Francois, Civrieux En Dombes (FR)

Correspondence Address: Plevy, Howard & Darcy, PC, Post Office Box 226, Fort Washington, PA, 19034, US

(21) Appl. No.: 11/018,876

(22) Filed: Dec. 21, 2004

(30) Foreign Application Priority Data
Dec. 26, 2003 (FR) 03/51208

(51) Int. Cl. H04L 5/12

(52) U.S. Cl. 375/377

(57) ABSTRACT

An asynchronous storing device receiving a binary event signal switching from a first level to a second level on each occurrence of a specific event, and a binary reset signal, this device providing a binary state signal at an inactive level when the specific event has not occurred yet, the state signal switching to an active level on first occurrence of the specific event, this device comprising a logic AND gate receiving the event signal, the state signal, and a binary intermediary signal switching values simultaneously with the reset signal; and a logic OR gate providing the state signal and receiving the output of the logic AND gate and the complement of the intermediary signal, the logic AND gate receiving the output of the logic OR gate.

### BACKGROUND OF THE INVENTION

1. Field of the Invention

The present invention relates to a device for storing the occurrence of a specific event.

2. Discussion of the Related Art

In many applications, it is desirable to provide a storing device capable of providing a state signal in an inactive state as long as a specific event has not occurred and which is set to an active state when the specific event occurs for the first time. Such a storing device finds an application, for example, in a warning system in which the storing device is connected to at least one sensor so that the storing device provides a state signal in the active state when the sensor has detected the occurrence of the specific event. An optical or sound signal may be actuated when the state signal of the storing device is in the active state.

Once the state signal is set to the active state, it is desirable for the state signal to remain in the active state whatever the subsequent variation of the signals provided by the sensor until the warning system is reset. This enables avoiding, especially, that a modification of the signals provided by the sensor, corresponding, for example, to a degradation of the sensor, causes the setting to the inactive state of the state signal. It is further desirable for the operation of the storing device not to be easily modified by an ill-intentioned person.

Such a storing device may be formed by software means. However, the operation of a software may be modified, for example, via a virus. The software operation could thus be modified to prevent the setting to the active state of the state signal provided by the storing device and prevent the emitting of a warning, or to force the setting to the inactive state to limit the duration of emission of a warning.

Such a storing device may be formed of dedicated circuits only. It may comprise logic gates and storing elements of flip-flop type having their operation synchronized by a clock signal. However, the operation of such a storing device may also be modified to prevent the setting to the active state of the state signal or force the return to the inactive state of a state signal set to the active state. Such a modification may be obtained, for example, by a disturbance of the clock signal or by a disturbance of the transmission sequence of the signals provided by the sensor according to the clock signal.

### SUMMARY OF THE INVENTION

The present invention aims at a storing device providing a state signal at an active level on first occurrence of a specific event which ensure the maintaining of the state signal in the active state whatever the subsequent variation of the signals received by the storing device and having an operation that cannot be easily modified.

To achieve this object, the present invention provides an asynchronous storing device receiving a binary event signal switching from a first level to a second level on each occurrence of a specific event, and a binary reset signal, this device providing a binary state signal at an inactive level when the reset signal is at a reset level, and when the reset signal is at a neutral level and the specific event has not occurred yet, the state signal switching to an active level on first occurrence of the specific event while the reset signal is at the neutral level, this device comprising a logic AND gate having a first input receiving the event signal, a second input receiving the state signal, and a third input receiving a binary intermediary signal switching values simultaneously with the reset signal, and a logic OR gate providing the state signal and having a first input receiving the output of the logic AND gate and a second input receiving the complement of the intermediary signal, the second input of the logic AND gate receiving the output of the logic OR gate.

According to an embodiment of the present invention, the third input of the logic AND gate receives the reset signal and the second input of the logic OR gate receives the output of a logic NOT gate receiving the reset signal.

According to an embodiment of the present invention, the third input of the logic AND gate receives the output of a logic NOT gate receiving the reset signal and the second input of the logic OR gate receives the reset signal.

The present invention also provides an asynchronous storing system comprising several asynchronous storing devices such as previously defined, each receiving an associated event signal, and a processing unit receiving the state signals provided by the storing devices and capable of performing a logic operation on the state signals to provide a binary final state signal at an active level as soon as each specific event associated with a storing device has occurred at least once.

According to an embodiment of the present invention, all the storing devices receive a same binary reset signal, the state signal associated with each storing device being set to an inactive level when the reset signal is at a determined level.

The present invention also provides an asynchronous storing system, comprising a succession of asynchronous storing devices such as previously defined, each providing a state signal associated with an active level on first occurrence of a specific associated event, the reset signal received by each storing device of the succession, except for the first storing device of the succession, corresponding to the state signal provided by the previous storing device of the succession, the state signal of the last storing device of the succession being at the active level on first occurrence, according to the succession order, of all the specific events associated with the storing devices.

The foregoing object, features, and advantages of the present invention will be discussed in detail in the following non-limiting description of specific embodiments in connection with the accompanying drawings.

### BRIEF DESCRIPTION OF THE DRAWINGS

FIGS. 1 to 10 respectively show diagrams of ten examples of embodiment of the storing device according to the present invention.

### DETAILED DESCRIPTION

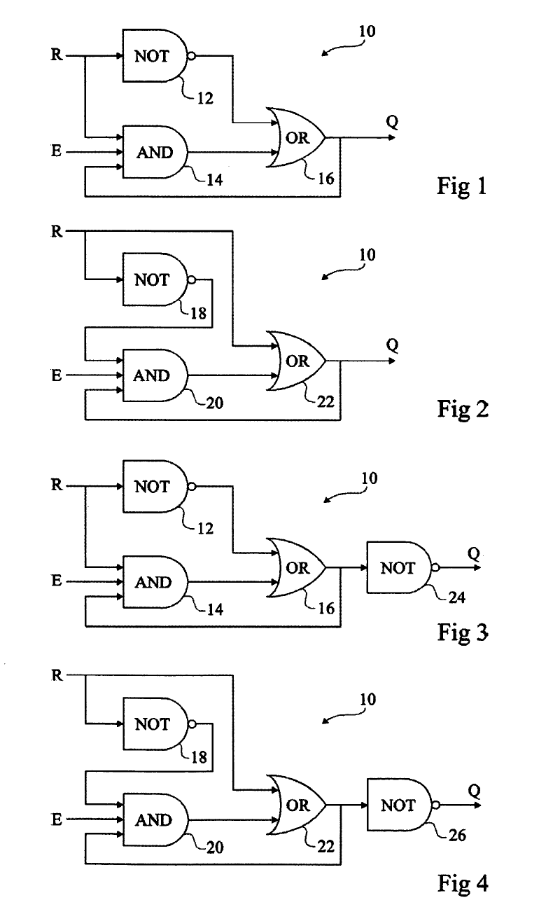

For the first eight examples shown in FIGS. 1 to 8, storing device 10, which will be hereafter called “lock”, receives a reset signal R and an event signal E and provides a state signal Q. Signals R, E, and Q are binary signals varying between two levels. For simplicity, the two levels that may be taken by signals R, E, and Q will be considered as being identical and designated by 0 and 1, but it should be clear that this might not be the case. Any transition of event signal E from 0 to 1 or from 1 to 0 is called an event. The specific event, the occurrence of which is desired to be stored corresponds, according to the example of forming of the considered lock 10, to the transition of event signal E from 0 to 1 or to the transition of event E from 1 to 0. Lock 10 is a monostable electronic storing device which has the function of asynchronously storing the first occurrence of the specific event. Lock 10 provides a state signal Q in an inactive state as long as the specific event has not occurred and in an active state on first occurrence of the specific event. Once the first occurrence of the specific event has been stored, the state signal is maintained in the active state until lock 10 turns off or until the reset signal is set to an active state. When the reset signal is set to the active state, the state signal provided by lock 10 is set to the inactive state.

FIG. 1 shows a first example of embodiment of storing device 10 comprising a logic NOT gate 12 receiving reset signal R, a three-input logic AND gate 14 receiving reset signal R, event signal E, and the output of a two-input logic OR gate 16 receiving the output of logic NOT gate 12 and the output of logic AND gate 14. Logic OR gate 16 provides state signal Q.

For the first example of embodiment of lock 10, reset signal R is active when it is at 0, the specific event corresponds to a transition of event signal E from 1 to 0 and state signal Q is active when it is at 0.

The truth table of the first example of embodiment of lock 10 is the following:

| R | E | Q0 | Q1 |
|---|---|---|---|
| 0 | X | X | 1 |
| 1 | 0 | 0 | 0 |
| 1 | 0 | 1 | 0 |
| 1 | 1 | 0 | 0 |
| 1 | 1 | 1 | 1 |

where symbol X means that the state of the considered signal is indifferently at 1 or at 0 and where Q0 and Q1 correspond to values of state signal Q at two successive times.

FIG. 2 shows a second example of embodiment of lock 10 according to the present invention comprising a logic NOT gate 18 receiving reset signal R, a logic three-input AND gate 20, receiving the output of logic NOT gate 18, event signal E, and the output of a two-input logic OR gate 22, receiving reset signal R and the output of logic AND gate 20. Logic OR gate 22 provides state signal Q.

For the second example of embodiment of lock 10, reset signal R is active when it is at 1, the specific event corresponds to a transition of event signal E from 1 to 0, and state signal Q is active when it is at 0.

The truth table of the second example of embodiment of lock 10 is the following:

| R | E | Q0 | Q1 |
|---|---|---|---|
| 0 | 0 | 0 | 0 |
| 0 | 0 | 1 | 0 |
| 0 | 1 | 0 | 0 |
| 0 | 1 | 1 | 1 |
| 1 | X | X | 1 |

In the two above-described examples of embodiment, logic AND gate 14, 20 receives reset signal R or its complement to avoid any oscillation of lock 10.

FIG. 3 shows a third embodiment of lock 10 according to the present invention having the same structure as the first example of embodiment, shown in FIG. 1, with the difference that the signal provided by logic OR gate 16 is transmitted to a logic NOT gate 24. State signal Q of lock 10 is the signal provided by logic NOT gate 24.

For the third example of embodiment of lock 10, reset signal R is active when it is at 0, the specific event corresponds to a transition of event signal E from 1 to 0, and state signal Q is active when it is at 1.

The truth table of the third example of embodiment of lock 10 is the following:

| R | E | Q0 | Q1 |
|---|---|---|---|
| 0 | X | X | 0 |
| 1 | 0 | 0 | 1 |
| 1 | 0 | 1 | 1 |
| 1 | 1 | 0 | 0 |
| 1 | 1 | 1 | 1 |

FIG. 4 shows a fourth example of embodiment of lock 10 having the same structures as the second example of embodiment of lock 10, shown in FIG. 2, with the difference that the signal provided by logic OR gate 22 is transmitted to a logic NOT gate 26. State signal Q of lock 10 is the signal provided by logic NOT gate 26.

For the fourth example of embodiment of lock 10, reset signal R is active when it is at 1, the specific event corresponds to a transition of event signal E from 1 to 0, and state signal Q is active when it is at 1.

The truth table of the fourth example of embodiment of lock 10 is the following:

| R | E | Q0 | Q1 |
|---|---|---|---|
| 0 | 0 | 0 | 1 |
| 0 | 0 | 1 | 1 |
| 0 | 1 | 0 | 0 |
| 0 | 1 | 1 | 1 |
| 1 | X | X | 0 |

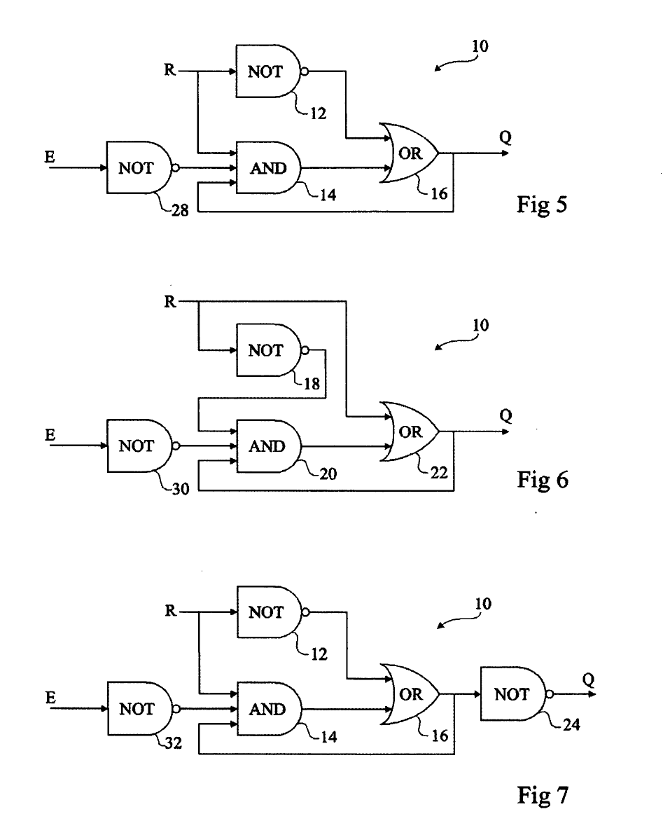

FIG. 5 shows a fifth example of embodiment of lock 10 having the same structure as the first embodiment, shown in FIG. 1, with the difference that logic AND gate 14 does not directly receive event signal E, but a signal provided by a logic NOT gate 28 receiving event signal E.

For the fifth example of embodiment of the lock according to the present invention, reset signal R is active when it is at 0, the specific event corresponds to a transition of event signal E from 0 to 1, and state signal Q is active when it is at 0.

The truth table of the fifth example of embodiment of lock 10 according to the present invention is the following:

| R | E | Q0 | Q1 |
|---|---|---|---|
| 0 | X | X | 1 |
| 1 | 0 | 0 | 0 |
| 1 | 0 | 1 | 1 |
| 1 | 1 | 0 | 0 |
| 1 | 1 | 1 | 0 |

FIG. 6 shows a sixth example of embodiment of the lock according to the present invention having the same structure as the second example of embodiment, shown in FIG. 2, with the difference that logic AND gate 20 does not directly receive event signal E, but rather a signal provided by a logic NOT gate 30 receiving event signal E.

For the sixth example of embodiment of the lock according to the present invention, reset signal R is active when it is at 1, the specific event corresponds to a transition of event signal E from 0 to 1, and state signal Q is active when it is at 0.

The truth table of the sixth example of embodiment of lock 10 according to the present invention is the following:

| R | E | Q0 | Q1 |
|---|---|---|---|
| 0 | 0 | 0 | 0 |
| 0 | 0 | 1 | 1 |
| 0 | 1 | 0 | 0 |
| 0 | 1 | 1 | 0 |
| 1 | X | X | 1 |

FIG. 7 shows a seventh example of embodiment of a lock 10 according to the present invention having the same structure as the third example of embodiment, shown in FIG. 3, with the difference that logic AND gate 14 does not directly receive event signal E, but rather receives a signal provided by a logic NOT gate 32 receiving event signal E.

For the seventh example of embodiment of lock 10 according to the present invention, reset signal R is active when it is at 0, the specific event corresponds to a transition of event signal E from 0 to 1, and state signal Q is active when it is at 1.

The truth table of the seventh example of embodiment of lock 10 is the following:

| R | E | Q0 | Q1 |
|---|---|---|---|
| 0 | X | X | 0 |
| 1 | 0 | 0 | 0 |
| 1 | 0 | 1 | 1 |
| 1 | 1 | 0 | 1 |
| 1 | 1 | 1 | 1 |

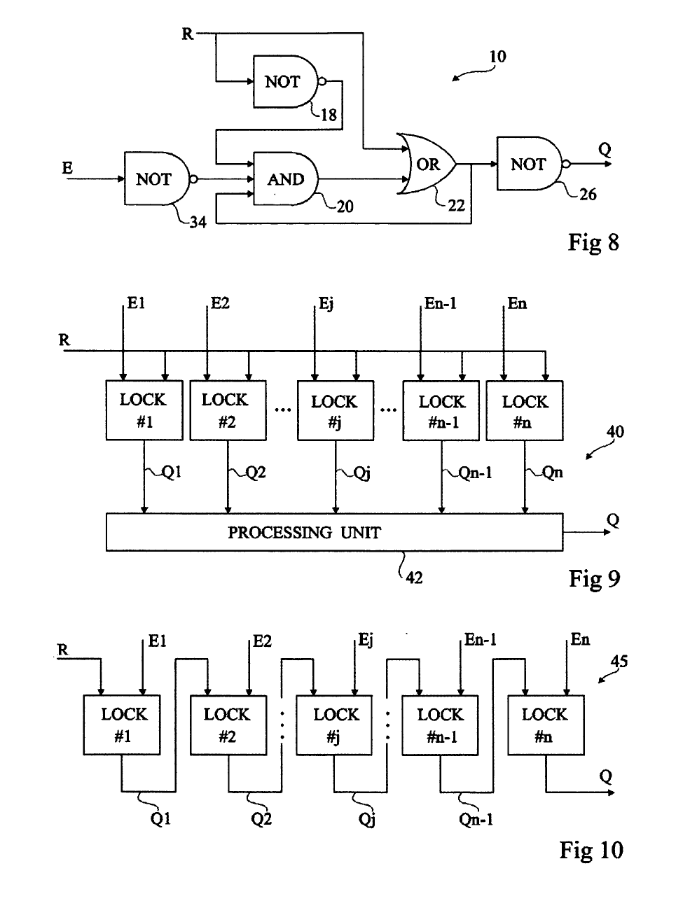

FIG. 8 shows an eighth example of embodiment of lock 10 according to the present invention having the same structure as the fourth example of embodiment of the lock, shown in FIG. 4, with the difference that logic AND gate 20 does not directly receive event signal E, but rather a signal provided by a logic NOT gate 34 which receives event signal E.

For the eighth example of embodiment of the lock according to the present invention, reset signal R is active when it is at 1, the specific event corresponds to a transition of event signal E from 0 to 1, and state signal Q is active when it is at 1.

The truth table of the eighth example of embodiment of locks 10 is the following:

| R | E | Q0 | Q1 |
|---|---|---|---|
| 0 | 0 | 0 | 0 |
| 0 | 0 | 1 | 1 |
| 0 | 1 | 0 | 1 |
| 0 | 1 | 1 | 1 |
| 1 | X | X | 0 |

In the previously-described examples of embodiment, state signal Q, or its complement, is looped back towards logic AND gate 14, 20, which further receives event signal E or its complement E. Such a configuration enables ensuring that, once set to the active state, state signal Q remains in the active state whatever the subsequent variation of event signal E, and this, until a new reset of lock 10 via reset signal Q. The setting to the inactive state of state signal Q is performed by the setting to the active state of reset signal R via logic OR gate 16, 22. The complement of the signal provided to logic OR gate 16, 22 (that is, signal R or its complement) is provided to logic AND gate 14, 20 to avoid any undetermined state of lock 10.

Further, in the previously-described examples of embodiment, lock 10 is formed by dedicated circuits and operates asynchronously. Lock 10 is thus particularly robust against conventional attacks specific to the software means and conventional attacks specific to the dedicated circuits, the operation of which is synchronized by a clock signal.

FIG. 9 shows a ninth example of embodiment of lock 40 according to the present invention. Lock 40 comprises n locks LOCK#j, j=1 to n, which each correspond to a lock 10 according to one of the previously-described embodiments, locks LOCK#J, j=1 to n, being not necessarily identical. All locks LOCK#j, j=1 to n, receive the same reset signal R. Each lock LOCK#j, j=1 to n, receives an event signal Ej, j=1 to n. Event signals Ej, j=1 to n, are a priori independent from one another. Each lock LOCK#j, j=1 to n, provides an intermediary state signal Qj, j=1 to n. A combinatory logic unit 42 receives the n intermediary state signals Qj, j=1 to n, performs a combinatory logic function over the n intermediary state signals Qj, j=1 to n, and provides state signal Q of lock 40. Lock 40 is set to the inactive sate when reset signal R is in the active state, for example, on powering on of lock 40. The combinatory logic function performed by lock 40 is such that state signal Q is set to the active state when all intermediary state signals Qj, j=1 to n, are in the active state. Since once it is in the active state, each intermediary signal Qj, j=1 to n, remains in the active state, once all intermediary signals Qj, j=1 to n, are in the active state, state signal Q of lock 40 remains in the active state. As an example, the logic combinatory function is a logic AND gate, with n inputs, receiving intermediary state signals Qj, j=1 to n.

FIG. 10 shows a tenth example of embodiment of lock 45 according to the present invention. Lock 45 comprises a succession of n locks LOCK#J, j=1 to n. Each lock LOCK#j, j=1 to n, corresponds to a lock 10 according to one of the previously-described eight first examples of embodiment, locks LOCK#j, j=1 to n, being not necessarily identical. First lock LOCK#j of the succession receives reset signal R. Each lock LOCK#J, j=2 to n, receives as a reset signal state signal Qj−1 of the previous lock LOCK#j−1, j=2 to n. A reset of a lock LOCK#J, j=2 to n, is performed when state signal Qj−1 of the previous lock LOCK#j−1, j=2 to n, is in the inactive state. State signal Q provided by the last lock LOCK#n in the succession corresponds to the state signal of lock 45. Each lock LOCK#j, j=1 to n, receives an event signal Ej, j=1 to n. State signal Q of lock 45 is set to the inactive state when reset signal R is in the active state, for example, on powering-on of lock 45. State signal Q of lock 45 is set to the active state when all the state signals Qj of locks LOCK#j, j=1 to n, become successively active in the order of increasing j values. Lock 45 thus has n+1 input signals, that is, reset signal R and event signals Ej, j=1 to n. It has one output signal, state signal Q.

Such a lock 45 is used when state signal Q is desired to be set to the active state when a succession of specific events occurs in a precise order. An advantage of such a lock is, further, that the maintenance can be performed at the level of one of locks LOCK#J, j=1 to n, without requiring complete stop of lock 45. Indeed, an intervention on lock LOCK#J, j=1 to n, does not modify the operation of the portions of lock 45 corresponding to locks LOCK#k, k=1 to j−1 and k=j+1 to n.

Of course, the present invention is likely to have various, alterations, improvements, and modifications which will readily occur to those skilled in the art. In particular, for the ninth and tenth previously-described examples of embodiment, at least one of locks LOCK#J, j=1 to n, may itself correspond to one of the locks according to the ninth or tenth embodiment.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1. An asynchronous storing device (10) receiving a binary event signal (E) switching from a first level to a second level on each occurrence of a specific event, and a binary reset signal (R), this device providing a binary state signal (Q) at an inactive level when the reset signal is at a reset level, and when the reset signal is at a neutral level and the specific event has not occurred yet, the state signal switching to an active level on first occurrence of the specific event while the reset signal is at the neutral level, this device comprising:
a logic AND gate (14, 20) having a first input receiving the event signal, a second input receiving the state signal, and a third input receiving a binary intermediary signal switching values simultaneously with the reset signal (R); and
a logic OR gate (16, 22) providing the state signal and having a first input receiving the output of the logic AND gate and a second input receiving the complement of the intermediary signal, the second input of the logic AND gate receiving the output of the logic OR gate.

2. The device of claim 1, wherein the third input of the logic AND gate (14) receives the reset signal (R) and the second input of the logic OR gate (16) receives the output of a logic NOT gate (12) receiving the reset signal.

3. The device of claim 1, wherein the third input of the logic AND gate (20) receives the output of a logic NOT gate (18) receiving the reset signal (R) and the second input of the logic OR gate (22) receives the reset signal.

4. An asynchronous storing system (40), comprising several asynchronous storing devices (LOCK#j) of claim 1, each receiving an associated event signal (Ej), and a processing unit (42) receiving the state signals (Qj) provided by the storing devices and capable of performing a logic operation on the state signals (Qj) to provide a binary final state signal (Q) at an active level as soon as each specific event associated with a storing device has occurred at least once.

5. The storing system of claim 4, wherein all the storing devices (LOCK#j) receive a same binary reset signal (R), the state signal (Qj) associated with each storing device being set to an inactive level when the reset signal is at a determined level.

6. An asynchronous storing system (45), comprising a succession of asynchronous storing devices (LOCK#j) of claim 1, each providing a state signal (Qj) associated with an active level on first occurrence of a specific associated event, the reset signal received by each storing device of the succession, except for the first storing device (LOCK#1) of the succession, corresponding to the state signal (Qj) provided by the previous storing device of the succession, the state signal (Q) of the last storing device (LOCK#n) of the succession being at the active level on first occurrence, according to the succession order, of all the specific events associated with the storing devices.
